(19) United States
(12) Patent Application Publication
(10) Pub. No.: US 2013/0232121 A1
(43) Pub. Date: Sep. 5, 2013

(54) METHOD AND SYSTEM FOR REMOTE STORAGE OF DATA

(71) Applicant: FILETREK INC., Ottawa (CA)

(72) Inventors: William Mark TUCKER, Ottawa (CA); Benjamin Freeman PIERCEY, Richmond (CA)

(73) Assignee: FILETREK INC., Ottawa (CA)

(21) Appl. No.: 13/781,933

(22) Filed: Mar. 1, 2013

Related U.S. Application Data
(60) Provisional application No. 61/605,554, filed on Mar. 1, 2012.

(51) Int. Cl. G06F 17/30

(52) U.S. Cl. CPC G06F 17/30283
USPC 707/655

(57) ABSTRACT

First and second local file systems remote one from another and having a hierarchical storage structure wherein files are stored within folders within the first local file system and the second local file system. A first file in the first local file system is mirrored to a second file in the second file system. When the first file is modified the second file is updated with the modifications to the first file. When the second file is modified the first file is updated with the modifications to the second file.

### FIELD OF THE INVENTION

The invention relates to communications and more particularly to a method and system for cloud based storage.

### BACKGROUND

Cloud based storage has been proposed and available for several years. Initial attempts at cloud based storage allowed organizations to back up their data into the “cloud”—an offsite storage facility. In the event of a disaster or other data recovery need, the stored data was retrievable from the cloud for use.

With increases to data communication bandwidth, the use of cloud-based storage has increased. Services like DropBox® have gained popularity providing the ability to store data via the World Wide Web and share stored data. DropBox® provides each user with a storage space in the cloud. The user optionally creates a DropBox folder mirroring their DropBox®—cloud based storage—on their computer system. The DropBox® folder on their local system synchronises to their cloud based storage automatically such that the user is able to interact with local storage in order to backup or share data.

Using DropBox®, when a user removes a file from their DropBox® folder, the file is removed from the folder for everyone sharing the file. Further, whenever someone with access to a file changes that file, the file within each DropBox® folder changes. Thus, each user can have access to a same file within the cloud that remains synchronized while working with a local copy of said file.

Unfortunately, when using DropBox® the DropBox® folder gets extremely crowded as when files are removed, everyone sharing those files loses access to those files. Thus, there is a tendency to not remove files. Further, unless all local storage is mirrored to the cloud, there is a tendency to maintain all files in duplicate so that file organization is maintained within the local store.

### SUMMARY OF EMBODIMENTS OF THE INVENTION

According to an embodiment of the invention there is provided a method comprising: providing a cloud storage; providing a first local data store, the first local data store in communication with the cloud storage via a data communication network; storing a first local file system in the first local data store, the first local file system having a hierarchical storage structure wherein files are stored within folders within the first local file system, a file forming a leaf of the hierarchical storage structure and wherein folders form nodes of the hierarchical storage structure; providing a first file within the first local file system as a leaf within a first folder; providing a second file within the first local file system as a leaf within the first folder; automatically mirroring the first file with a first cloud file within the cloud storage by transmitting first file data from the first local data store to the cloud storage via the data communication network; and other than mirroring the second file with a second cloud file within the cloud storage.

According to an embodiment of the invention there is provided a method comprising providing a first local data store; storing a first local file system in the first local data store having a hierarchical storage structure wherein files are stored within folders within the first local file system, a file forming a leaf of the hierarchical storage structure and wherein folders form nodes of the hierarchical storage structure; storing a first file within the first local file system as a leaf within a first folder; providing a second local data store; providing a second local file system in the second local data store having a hierarchical storage structure wherein files are stored within folders within the second local file system, a file forming a leaf of the hierarchical storage structure and wherein folders form nodes of the hierarchical storage structure, the second local file system remote from the first local file system; providing cloud storage in data communication with the first local data store and the second local data store; mirroring the first file with a first cloud file within the cloud storage comprising transmitting first file data from the first local data store to the cloud storage via the communication network; mirroring the first cloud file with a third file within the second local file system and forming a leaf within a third folder comprising transmitting first cloud file data from the cloud storage to the second local data store via the communication network; storing a second file within the first local file system as a leaf within the first folder; and other than mirroring the second file with a fourth file within the second local file system.

In accordance with an embodiment of the invention there is provided a method comprising: providing a plurality of local data stores, each one of the plurality of local data stores comprising at least one of a first plurality of files; providing a first cloud storage in data communication with the plurality of data stores via a data communication network; mirroring within a first cloud storage the first plurality of files by transmitting file data for each one of the first plurality of files from the plurality of data stores to the first cloud storage via the data communication network; mirroring within the first cloud storage a second plurality of files, each of the second plurality of files mirrored with files in at least two local file systems, the two local file systems remote one from anther; and storing for each of the second plurality of files file location data, the file location data indicative of a location within each of the at least two local file systems for the mirrored files therein, the file location data different for different instances of the second plurality of location data such that files mirrored in each of the at least two local file systems other than have a same relative file location.

### BRIEF DESCRIPTION OF THE DRAWINGS

Embodiments of the invention are now described with references to the drawings in which:

FIG. 1 is a simplified diagram of two file systems according to the prior art supporting cloud based storage;

FIG. 2 is a simplified diagram of two file systems according to the prior art supporting cloud based file sharing;

FIG. 3 is a simplified diagram of two file systems according to an embodiment of the invention and supporting cloud based file synchronization of files;

FIG. 4 is a simplified flow diagram of a process for supporting cloud based file synchronization of files and relying on the file systems of FIG. 3;

FIG. 5 is a simplified diagram of two file systems according to an embodiment of the invention and supporting cloud based file synchronization of files;

FIG. 6 is a simplified flow diagram of a process for supporting cloud based file synchronization of files and relying on the file systems of FIG. 5;

FIG. 7 is a simplified flow diagram of a process for supporting cloud based file synchronization of files and relying on the file systems of FIG. 5;

FIG. 8 is a simplified flow diagram of a process of versioning file data within a cloud based file synchronisation process and system;

FIG. 9a is a simplified diagram of three file systems according to an embodiment of the invention and supporting permission based file management of shared files wherein mirrored files in remote storage are deleted;

FIG. 9b is a simplified diagram of three file systems according to an embodiment of the invention and supporting permission based file management of shared files wherein mirrored files in remote storage are deleted other than the mirrored file in the cloud;

FIG. 9c is a simplified diagram of three file systems according to an embodiment of the invention and supporting permission based file management of shared files wherein a file in a local data store is deleted;

FIG. 10a is a diagram of two local data stores comprising synchronised files and a table wherein the locations of synchronized files are stored;

FIG. 10b is a diagram of two local data stores comprising synchronised files.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

### DEFINITIONS

Cloud Storage: File storage within a remote location accessed via a wide area network and managed and operated by a third party.

File System: The term file system refers to a system for file storage having a file organization architecture for organizing and locating files. Though the term file system is used, it is recognized that cloud based storage need not be in a single system nor need it be in a same data store at any given time or over a period of time.

Local File System refers to a system for file storage having a file organization architecture for organizing and locating files and that is local to single system or network. Local file systems include file systems within LAN servers, local hard drives, and removable media, for example. Local File Systems exclude cloud based storage.

Mirrored is defined as copying a file to create one or more copies of the file and when the file or one of the copies of the files are changed the file or one of the copies of the files are synchronised.

Synchronised: two or more files are considered to be synchronized when one of said two or more files is changed, the changes are then propagated to the other of said two or more files, for example, by copying the changed file, such that more than one file is synchronized most of the time.

Relative file location is defined as a file location relative to another file. Two files A and B have the same relative location as two other files C and D if and only if the minimum folders to encompass A and B have the same names and relations as the minimum folders to encompass C and D. For example, when A and B are each in separate folders HELLO and WORLD within a parent folder Q, then A and B have a same relative file structure to C and D when C and D are stored on a different storage medium in respective folders HELLO and WORLD within parent folder Q, even where parent folder Q is not within a same parent folder for each storage medium.

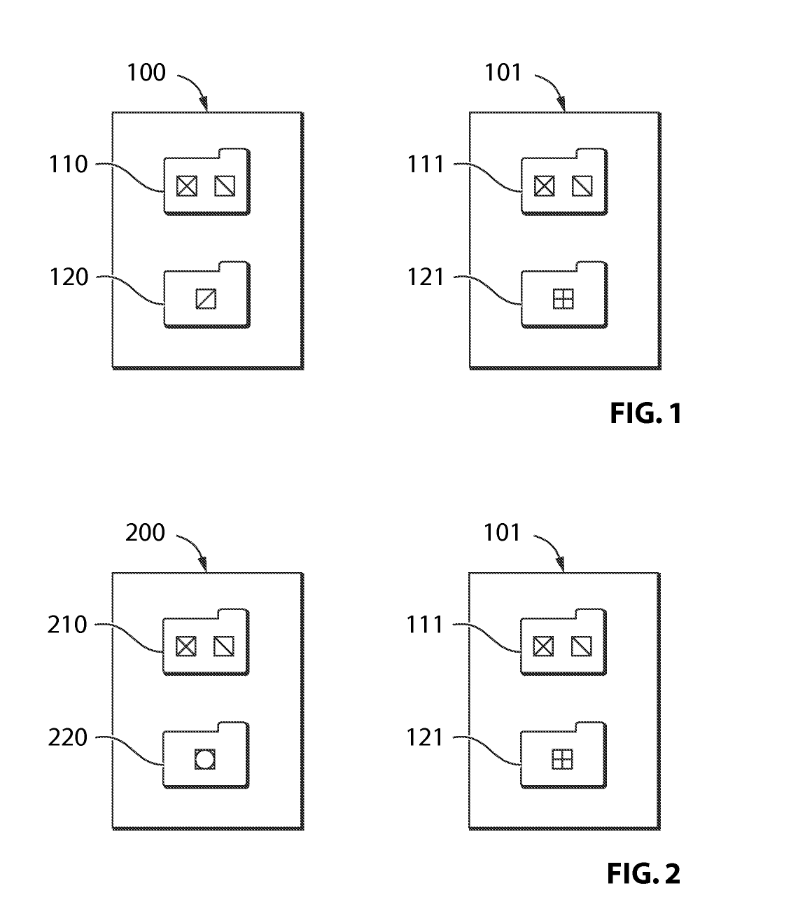

Referring to FIG. 1, shown is a simplified diagram of two file systems according to the prior art. File system 100 is a local file system stored for a single local computer system and file system 101 is within the cloud. Folders 110 and 111 are mirrored—they each consist of same data when fully synchronised. Folders 120 and 121 are other than mirrored. For example, folder 120 comprises data that is private to a user of the local computer while folder 121 belongs to another user in communication with the cloud.

When a user of the local computer system moves a file from folder 120 to folder 110, a process is initiated for synchronizing the folder 110 and the folder 111—the data for the moved file is copied from the local storage to the cloud storage.

Referring to FIG. 2, shown is a simplified diagram of two file systems according to the prior art. File system 200 is a local file system stored for a single local computer system and file system 101 is within the cloud. Folders 210 and 111 are mirrored—they each consist of same data when fully synchronised. Folders 220 and 121 are other than mirrored. For example, folder 220 comprises data that is private to a user of the local computer while folder 121 belongs to another user in communication with the cloud.

When a user having access to folder 111 moves a file into that folder, a process is initiated for synchronizing the folder 210 and the folder 111—the data for the moved file is copied from the cloud storage to the local storage. Thus, within a shared folder within a cloud storage or within a storage synchronized with a cloud storage, files and folders change as users of those files and folders modify same. As will be noted, some files on file system 200 and file system 200 are synchronized one with the other via the cloud based storage.

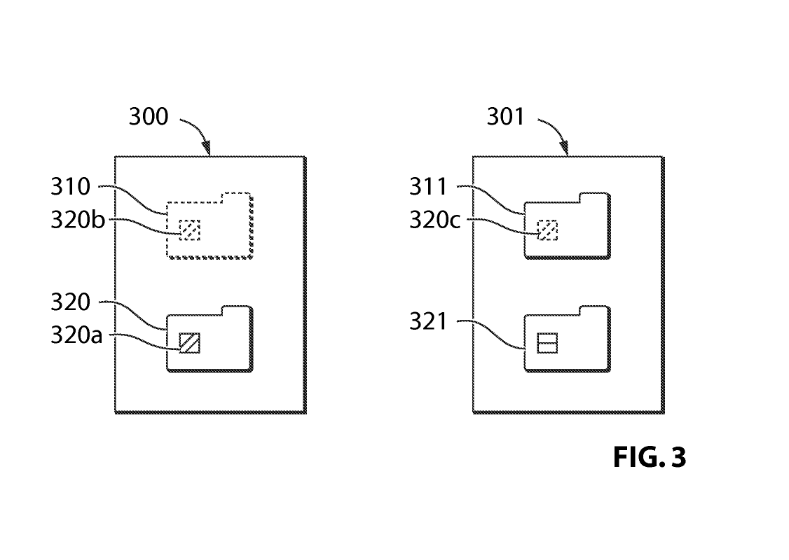

Referring to FIG. 3, shown is a simplified diagram of two file systems according to an embodiment of the invention. File system 300 is a local file system stored for a single local computer system and file system 301 is within the cloud. Folder 310 is hidden and therefore does not appear to a user of the file system 300. Folders 310 and 311 are mirrored—they each consist of same data when fully synchronised. Folders 320 and 321 are other than mirrored. For example, folder 320 comprises data that is private to a user of the local computer while folder 321 belongs to another user in communication with the cloud.

When a user having access to folder 320 decides to share a file 320a, the file 320a is selected and a share option is initiated. For example, a right mouse click is used to bring up a menu of options and a cloud-share option is selected. Alternatively, a utility is executed for selecting and managing files to be shared. The selected file is moved into hidden folder 310 as shown in dashed lines at 320b. An alias of the moved file is stored in its place within folder 320—appearing as if the file is unmoved—and allows for user interaction with the file in its designated file location. The file 320a stored in folder 310 is then mirrored in folder 311 within file system 301 by transmitting file 320b file data to folder 311 via a data communication network and storing as file 320c, shown in dashed lines.

Thus, a similar technical approach to that of the prior art is employable but the user perceives the file as being shared in situ. Advantageously, files that are stored within a cloud storage are not necessarily rearranged on the local storage which presents the user with a more normal file system. Further advantageously, a file to be shared and organized need not be duplicated eliminating much of the complexity of version management for said file.

When the file shared via cloud storage is changed, a synchronization event updates the copy of said file within folder 310. Once so updated, the alias allows interaction with a file that is synchronized with the cloud based storage and optionally synchronized with other local storage.

Optionally, selection of a file within a synchronized folder allows for “moving” of said file by dragging and dropping or by selecting a function with the file—for example right clicking. When the file is moved, an alias is created at the destination location and the original file is hidden such that the synchronized file appears to have been moved. In this fashion, shared folders remain for sharing and synchronizing within the cloud, but the local user can access and organize the shared files more effectively.

The embodiment of FIG. 3 is advantageous even when a file is merely to be stored in cloud storage and not shared. Here, the ability to place a file in cloud storage without apparently moving said file from its organized location is beneficial. Any local changes made to that file are synchronized with the cloud storage without a user having to remember where the file is stored. If the file were duplicated and the duplicate stored in the folder 310, then updating the file in folder 311 would not result in cloud storage of the updated file. As such, any method requiring the user to organize their file version management manually is likely to fail in at least some cases.

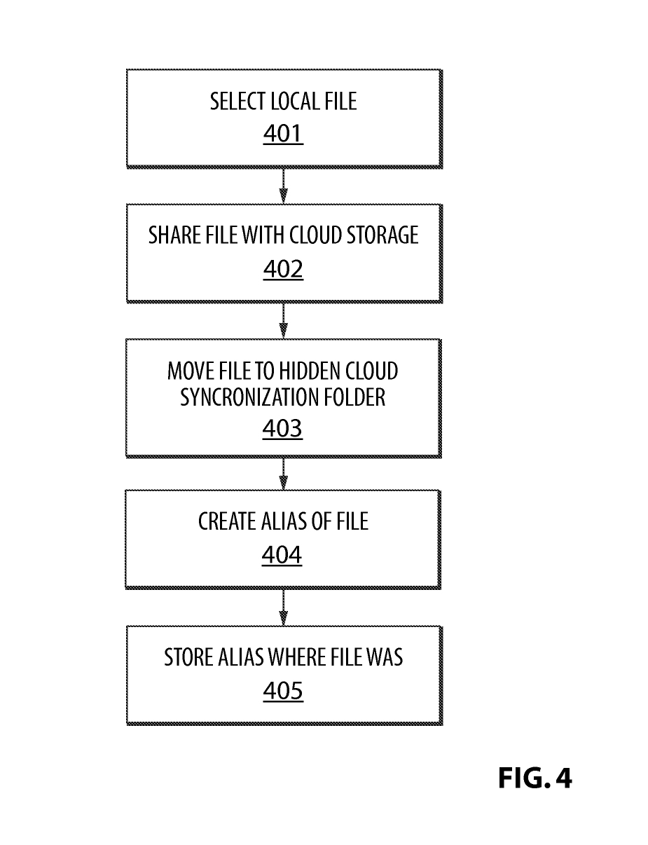

Referring to FIG. 4, shown is a simplified flow diagram of a process such as the one described with reference to FIG. 3. A file within a first folder of a local store is selected at 401. A user decides to share the file with cloud storage at 402 and indicates such, for example by selecting an action from a menu for application to the selected file. At 403, the file is moved to a cloud synchronization folder that is hidden and is mirrored within the cloud via the data communication network. At 404, an alias of the moved file is created and at 405 the alias is stored in the first folder.

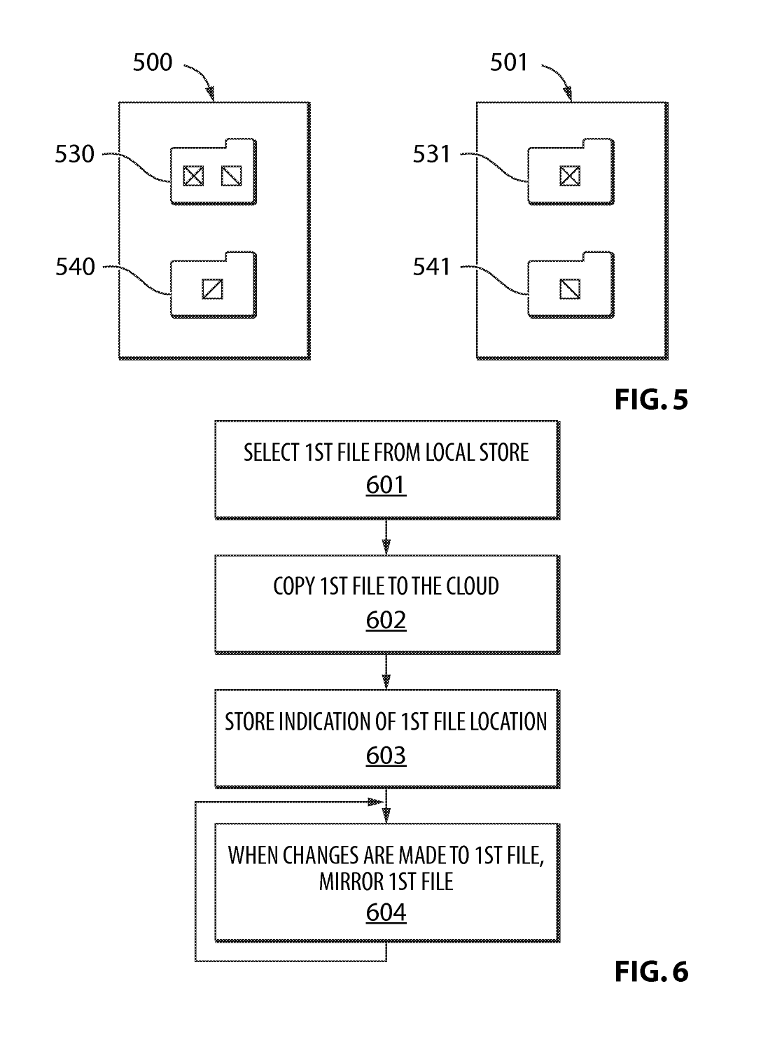

Referring to FIG. 5, shown is a simplified diagram of two file systems according to another embodiment of the invention. File system 500 is a local file system stored for a single local computer system and file system 501 is within the cloud. Folders 530 and 540 are within local file system 500. Folders 531 and 541 are within file system 501 forming part of a cloud storage. Of note, folders 530 and 531 are other than mirrored. Further, folders 540 and 541 are other than mirrored.

When a user having access to folder 530 decides to share a file, the file is selected, a share option is initiated and file data in folder 530 is transmitted to the destination folder on remote storage, in the form of file system 501, via a data communication network. For example, a right mouse click is used to bring up a menu of options and a cloud-share option is selected. Alternatively, a utility is executed for selecting and managing files to be shared. The selected file in folder 530 is then mirrored with a file within the cloud. For example, a similar file structure to the local file system is created within the cloud and the mirrored file is stored in accordance with the similar structure. Alternatively, the synchronized file is stored within the cloud and referenced with data indicating its local file system storage location. Further alternatively, the synchronized file is stored within the cloud and the local file system storage location is stored and noted within data used for synchronization and stored on the local system. Using such an embodiment allows for a same synchronized file to be stored in numerous different local file stores in different locations and to remain synchronized.

Thus, a similar result to that of the embodiment of FIG. 3 is achieved where the user perceives the file as being shared in situ. Advantageously, files that are stored within a cloud storage are not necessarily rearranged on the local storage which presents the user with a more normal file system. Further advantageously, a file to be shared and organized need not be duplicated eliminating much of the complexity of version management for said file.

When the file shared via cloud storage is changed, a synchronization event updates the copy of said file within folder 530. Once so updated, the alias allows interaction with a file that is synchronized with the cloud based storage and optionally synchronized with other local storage.

The embodiment of FIG. 5 is advantageous even when a file is merely to be stored in cloud storage and not shared. Here, the ability to place a file in cloud storage without apparently moving said file from its organized location is beneficial. Any local changes made to that file are synchronised with the cloud storage without a user having to remember where the file is stored.

Referring to FIG. 6, shown is a simplified flow diagram for a process for mirroring a file in the system as shown in FIG. 5. A user selects a first file within local storage for being stored within the cloud at 601. At 602, the file is copied to the cloud and stored within cloud storage via the communication network. At 603, an indication of a location of the first file is stored within the cloud. At 604, when changes are made to the first file, mirroring occurs such that the changes are reflected in the cloud version of the first file.

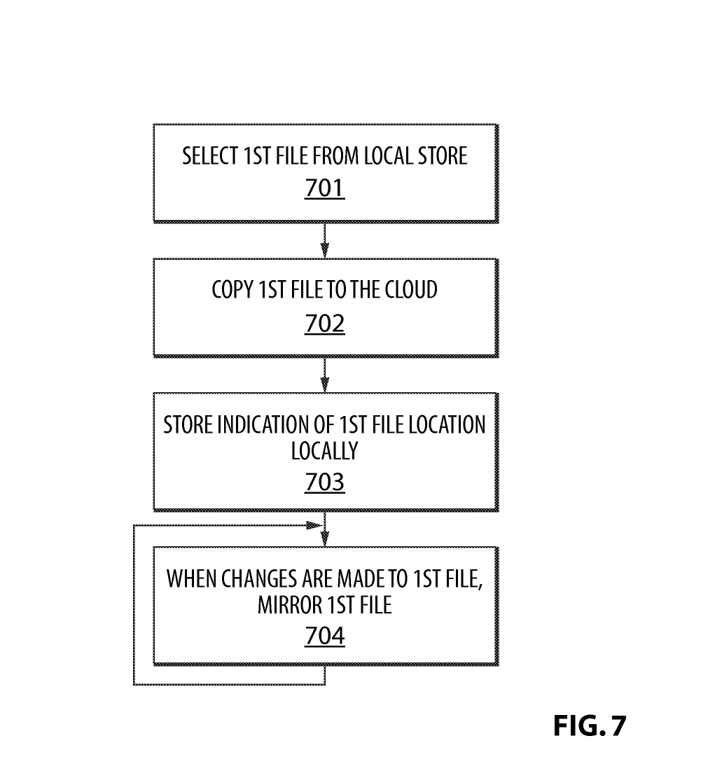

Referring to FIG. 7, shown is another simplified flow diagram for a process for mirroring a file in the system as shown in FIG. 5. A user selects a first file within local storage for being stored within the cloud at 701. At 702, the file is copied to the cloud and stored within cloud storage via the communication network. At 703, an indication of a location of the first file is stored within the local storage for use by a file mirroring process. At 704, when changes are made to the first file, mirroring occurs such that the changes are reflected in the cloud version of the first file.

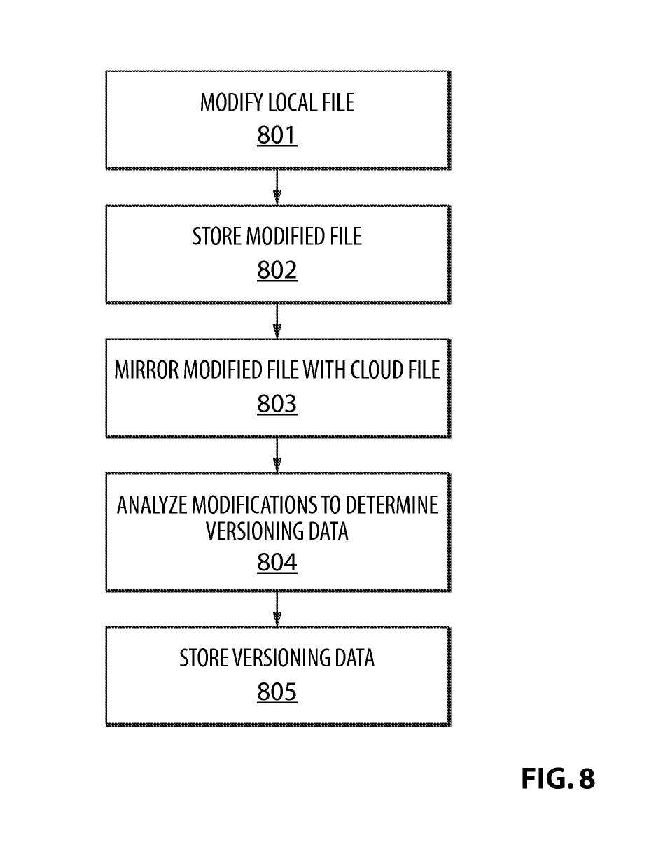

Referring to FIG. 8, shown is an embodiment of the invention wherein synchronized files are also managed over time to track changes thereto. Change management is a well-understood field allowing for users to see how a file has been changed and optionally by whom. Further, change management is also useful in helping to resolve conflicts or assisting in their identification.

The change management process of FIG. 8 will be described with reference to the file system of FIG. 5. The process is equally applicable to other embodiments of the present invention or to the prior art.

A plurality of files are mirrored—some local and some within the cloud. Typically, local files are modified whereas cloud files are merely updated through synchronizing. That said, some cloud based mirroring systems provide a mechanism for directly accessing the mirrored file within the cloud.

At 801a first file stored in local storage is modified. The modifications are stored at 802. At 803 the modifications are mirrored first to the cloud, and then to other users' local storage that are also to be synchronized with the first file. The synchronisation occurs via the data communication network. At 804, a cloud server compares the first file before it was modified and the first file after being modified and at 805 stores an indication of the changes along with the an indication of the local store where the file was changed. Alternatively, an indication of the user who changed the file is stored. Further alternatively file changes are tracked in isolation.

At a later time, users having access to the file retrieve versioning data relating to when the file was changed and how. Thus, if someone inadvertently changes a file, the versioning data allows for the original file to be reconstructed. Advantageously, as files and folders are shared inadvertent actions by a recipient need not affect everyone's ability to access the data that was shared.

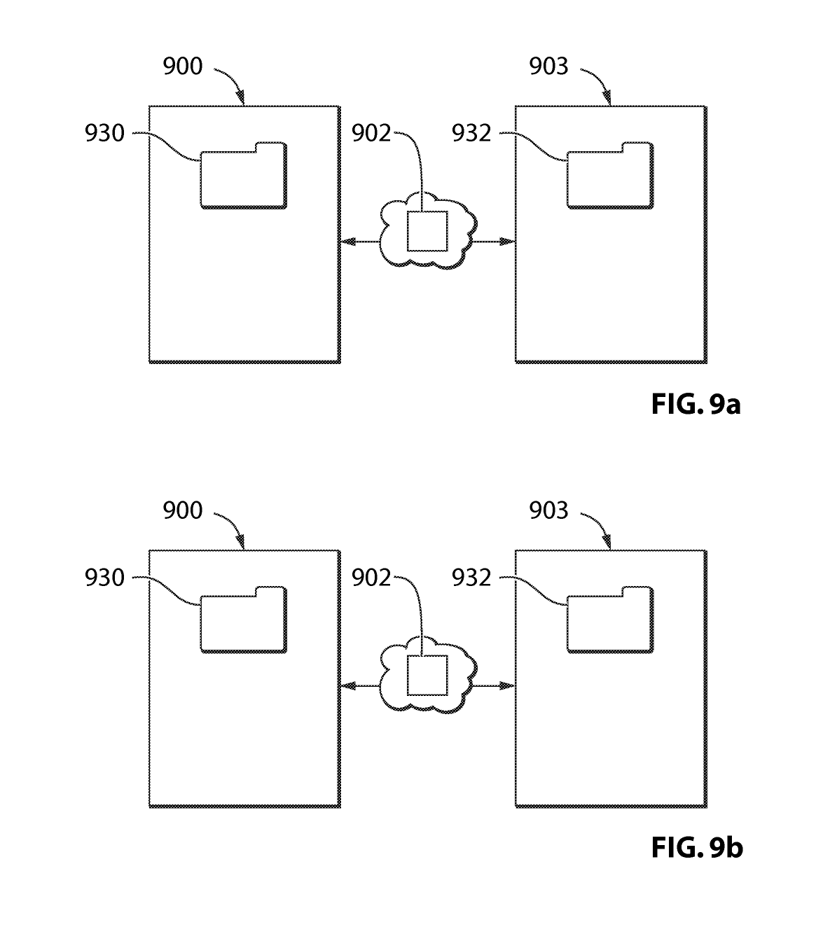

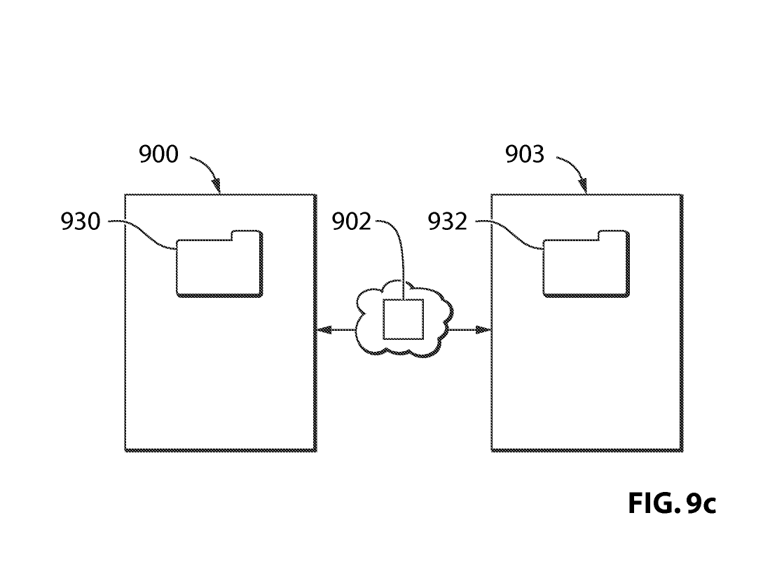

Permission based file management of shared files provides control over the deletion of mirrored files. System file data embedded into a shared file comprises deletion permission information that is input into a deletion utility. The deletion utility processes the deletion permission information and determines which of the mirrored files can be deleted. System file data is specific to each shared file and is other than copied when a file is mirrored. For example, referring to FIG. 9a, shown is a simplified diagram of three file systems according to another embodiment of the invention. A first file in folder 930 is stored in local storage 900 and is shared via cloud storage 902 with a second folder 932 on local storage 903. Local storage 900, cloud storage 902, and local storage 903 are in data communication with a data communication network. The user having access to the first file in folder 930 no longer wishes to share the first file with a second user who has access to the mirrored file in folder 932. The first file comprises first file system data providing information to a deletion utility that it is permitted to delete all mirrored files of the first file. The first user selects the first file, for example by right clicking the file, and an option to delete all mirrored files appears in a menu, which the user selects. The deletion utility processes the deletion permission information in the system file data of the first file and determines which of the mirrored files can be deleted. A deletion utility initiates a process for deleting all mirrored files of the first file, and in this example the file in cloud based storage 902 and the file in folder 932 on local storage are deleted by the deletion utility process via the data communication network. Alternatively, a menu is other than used to initiate the deletion utility, e.g., the deletion utility is initiated by the user opening the deletion utility software program. Optionally, if any other files located on other data stores remote from the local storage 900 are shared with the first file the deletion utility initiates a process and the other files are deleted via the data communication network

Referring to FIG. 9b, the first file in cloud storage 902 need not be deleted. The first user may prefer to keep the first file in remote cloud storage 902 which is a more reliable storage than the local storage 900. The first user selects the first file, for example by right clicking the file, and an option to delete all mirrored files of the first file other than the file in cloud storage 902 appears in a menu which the user selects. The deletion utility processes the deletion permission information in the system file data of the file located in local data store 903 and determines which of the mirrored files can be deleted. The deletion utility initiates a process deleting all mirrored files of the first file other than the file in cloud storage 902 and in this example the file in folder 932 on local storage is deleted by the deletion utility process via the data communication network. Alternatively, a menu is other than used to initiate the deletion utility, e.g., the deletion utility is initiated by the user opening the deletion utility software program. Optionally, if any other files located on other data stores, excluding cloud storage 902, remote from the local data store 900 are shared with the first file the deletion utility initiates a process and the other files are deleted by the deletion utility process via the data communication network.

Alternatively, the first user wishes to delete the first file and all mirrored files of the first file. The first user selects the first file, for example, by right mouse clicking on the file and a menu appears comprising a delete first file and all mirrored files option, which the first user selects. The deletion utility processes the deletion permission information in the system file data of the file located in local data store 903 and determines which of the mirrored files can be deleted. The deletion utility initiates a process to delete all mirrored files of the first file and the first file. In this example the first file in local data store 900 is deleted by the deletion utility process. Also deleted are the file in folder 932 on local storage 903 and the file in cloud storage 902 by the deletion utility process via the data communication network. Alternatively, a menu is other than used to initiate the deletion utility, instead the deletion utility is initiated by the user opening the deletion utility software program. Optionally, if any other files located on other data stores remote from the local data store 900 are shared with the first file the deletion utility initiates a process and the other files are deleted by the deletion utility process via the data communication network.

Referring to FIG. 9c, the second user may wish to no longer keep the file in local storage 903. The file in local storage 903 comprises file system data providing information to the deletion utility that it is permitted to delete the file in the local storage 903 but other than permitted to delete any other files. The second user selects the file in local storage 903, for example by right clicking the file, a menu appears and an option to delete the file is selected by the second user. The deletion utility processes the deletion permission information in the system file data of the file located in local data store 903 and determines which of the mirrored files can be deleted. The deletion utility initiates a process to delete the file in local storage 903. The deletion of the file in folder 932 other than deletes the first file in cloud storage 902 or from local storage 900. Also, any data stores remote from local data store 903 comprising mirrored files of the first file are other than deleted. Alternatively, a menu is other than used to initiate the deletion utility, e.g., the deletion utility is initiated by the user opening the deletion utility software program.

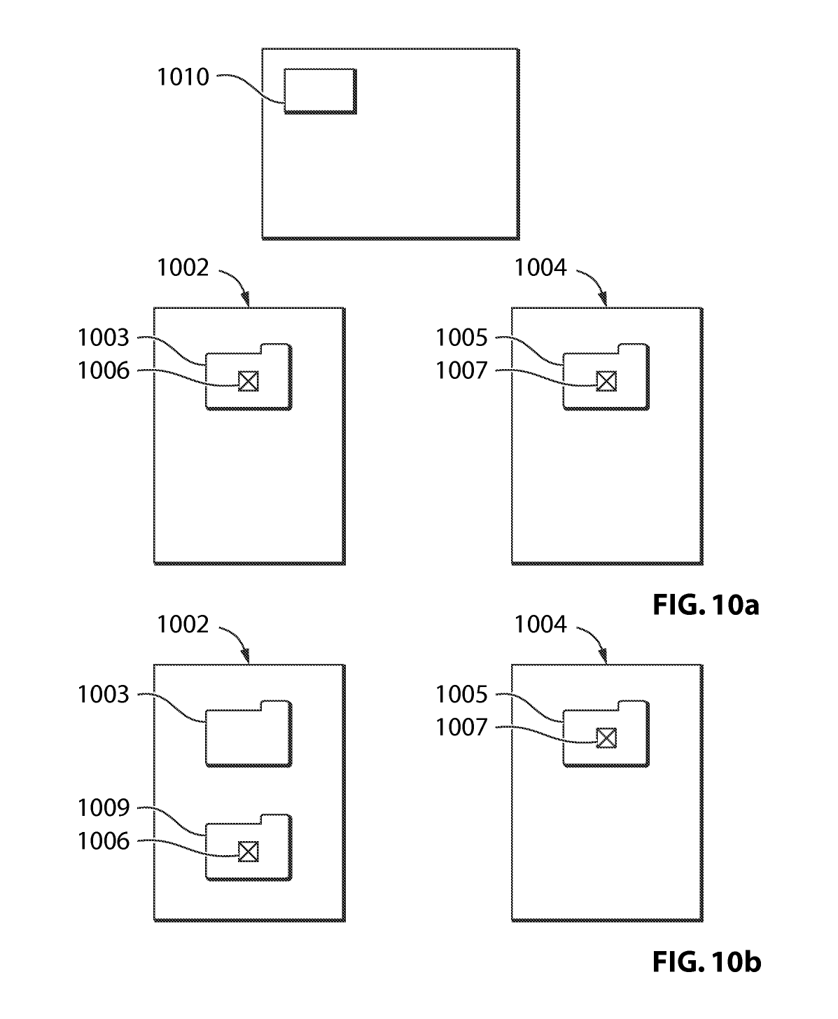

According to another embodiment of the invention, the location of synchronized files are stored in a table, for example, table 1001 in FIG. 10a. Local storage 1002 comprises folder 1003 wherein file 1006 is stored. A user shares file 1006, using one of the methods described above, with file 1007 stored in folder 1005 within storage 1004. The table entry 1010 comprises location information of file 1006 including an indication of the folder 1003 where it is stored, location information of file 1007 including an indication of the folder 1005 where it is stored and mirroring information comprising the relationship of the two files, in this example file 1007 is a mirror of file 1006. The user moves file 1006 to folder 1009 as shown in FIG. 10b and table entry 1010 is modified wherein the indication of the location of file 1006 is changed from folder 1006 to folder 1009. The mirroring information and the location information of file 1007 remains unchanged. Alternatively, a new table entry is created in table 1001. Alternatively, file 1007 is moved from folder 1005 to another location and table entry 1010 is modified accordingly. Further alternatively when a mirrored file, or the mirror of a file, is modified, a table is searched for table entries comprising information associated with the modified file and this information is used for synchronizing files.

Numerous embodiments of the invention will be apparent to one of skill in the art without departing from the scope of the invention.

What is claimed is:

1. A method comprising:
providing a cloud storage;
providing a first local data store, the first local data store in communication with the cloud storage via a data communication network;
storing a first local file system in the first local data store, the first local file system having a hierarchical storage structure wherein files are stored within folders within the first local file system, a file forming a leaf of the hierarchical storage structure and wherein folders form nodes of the hierarchical storage structure;
providing a first file within the first local file system as a leaf within a first folder;
providing a second file within the first local file system as a leaf within the first folder;
automatically mirroring the first file with a first cloud file within the cloud storage by transmitting first file data from the first local data store to the cloud storage via the data communication network; and
other than mirroring the second file with a second cloud file within the cloud storage.

2. A method according to claim 1 comprising:
providing a second local data store in communication with the cloud storage via the data communication network;
storing a second local file system in the second local data store remote from the first local file system and having a hierarchical storage structure wherein files are stored within folders within the second local file system, a file forming a leaf of the hierarchical storage structure and wherein folders form nodes of the hierarchical storage structure; and
mirroring a third file within the second local file system as a leaf within a third folder with the first cloud file within the cloud storage by transmitting first cloud file data from the cloud storage to the second local data store via the data communication network

3. A method according to claim 2 comprising:
providing a fourth file within the second local file system as a leaf within the third folder; and
other than mirroring the fourth file with a third cloud file within the cloud storage.

4. A method according to claim 1 wherein the first file is mirrored with the first cloud file within a first cloud folder and comprising:
providing a fifth file within the first local file system as a leaf within the first folder; and
mirroring the fifth file with a fifth cloud file within the cloud storage within a fifth cloud folder different from the first cloud folder by transmitting fifth file data from the first local data store to the cloud storage.

5. A method according to claim 1 comprising:
providing a fifth file within the first local file system as a leaf within the first folder; and
mirroring the fifth file with a fifth cloud file within a second cloud storage by transmitting fifth file data from the first local storage to the second cloud storage.

6. A method according to claim 1 comprising:
providing a fifth file within the first local file system as a leaf within a second folder; and
mirroring the fifth file with a fifth cloud file within a second cloud storage by transmitting fifth file data from the first local storage to the second cloud storage.

7. A method according to claim 1 comprising:
providing a second local data store;
storing a second local file system in the second local data store remote from the first local file system and having a hierarchical storage structure wherein files are stored within folders within the second local file system, a file forming a leaf of the hierarchical storage structure and wherein folders form nodes of the hierarchical storage structure;
providing a third file within the second local file system within a third folder; and
mirroring the third file within the second local file system with a third cloud file within the cloud storage, the third cloud file within a same cloud folder as the first cloud file, by transmitting third cloud file data from the cloud storage to the second local data store via the data communication network.

8. A method according to claim 1 wherein automatically mirroring is performed at intervals.

9. A method according to claim 8 wherein the intervals are punctuated when changes are made to either file that is mirrored.

10. A method according to claim 1 wherein the first file and the second file each comprise user generated data.

11. A method comprising:
providing a first local data store;
storing a first local file system in the first local data store having a hierarchical storage structure wherein files are stored within folders within the first local file system, a file forming a leaf of the hierarchical storage structure and wherein folders form nodes of the hierarchical storage structure;
storing a first file within the first local file system as a leaf within a first folder;
providing a second local data store;
providing a second local file system in the second local data store having a hierarchical storage structure wherein files are stored within folders within the second local file system, a file forming a leaf of the hierarchical storage structure and wherein folders form nodes of the hierarchical storage structure, the second local file system remote from the first local file system;
providing cloud storage in data communication with the first local data store and the second local data store;
mirroring the first file with a first cloud file within the cloud storage comprising transmitting first file data from the first local data store to the cloud storage via the communication network;
mirroring the first cloud file with a third file within the second local file system and forming a leaf within a third folder comprising transmitting first cloud file data from the cloud storage to the second local data store via the communication network;
storing a second file within the first local file system as a leaf within the first folder; and
other than mirroring the second file with a fourth file within the second local file system.

12. A method according to claim 11 comprising:
providing a fourth file within the second local file system as a leaf within the third folder; and
other than mirroring the fourth file with a second cloud file within the cloud storage.

13. A method according to claim 12 comprising:
storing a fifth file within the first local file system as a leaf within the first folder; and
mirroring the fifth file with the third file within the second local file system and forming a leaf within a third folder by transmitting fifth file data from the cloud storage to the second local data store via the data communication network.

14. A method according to claim 11 comprising:
providing a fifth file within the first local file system as a leaf within the first folder; and
mirroring the fifth file with a fifth cloud file within a second cloud storage by transmitting fifth file data from the first local data store to the second cloud storage via the data communication network.

15. A method according to claim 11 comprising:
providing a fifth file within the first local file system as a leaf within a second folder; and
mirroring the fifth file with a fifth cloud file within a second cloud storage by transmitting fifth file data from the first local data store to the second cloud storage via the data communication network.

16. A method according to claim 11 wherein automatically mirroring is performed at intervals.

17. A method according to claim 16 wherein the intervals are punctuated when changes are made to either file that is mirrored.

18. A method according to claim 11 wherein the first file and the second file each comprise user generated data.

19. A method comprising:
providing a plurality of local data stores, each one of the plurality of local data stores comprising at least one of a first plurality of files;
providing a first cloud storage in data communication with the plurality of data stores via a data communication network;
mirroring within a first cloud storage the first plurality of files by transmitting file data for each one of the first plurality of files from the plurality of data stores to the first cloud storage via the data communication network;
mirroring within the first cloud storage a second plurality of files, each of the second plurality of files mirrored with files in at least two local file systems, the two local file systems remote one from anther; and
storing for each of the second plurality of files file location data, the file location data indicative of a location within each of the at least two local file systems for the mirrored files therein, the file location data different for different instances of the second plurality of files file location data such that files mirrored in each of the at least two local file systems other than have a same relative file location.

20. A method according to claim 19 comprising:
within a cloud performing version management for mirrored files, the version management resulting in storing of at least some data relating to changes to files stored within the cloud storage.

21. A method according to claim 20 wherein the at least some data comprises data for undoing changes made to at least a mirrored file.

22. A method according to claim 19 comprising:
within a cloud performing version management for mirrored files, the version management resulting in storing of at least some data relating to changes to files made in local copies of said files, said local copies stored within local file systems and mirrored to the cloud storage, the at least some data stored within the cloud storage.

23. A method according to claim 22 wherein the at least some data comprises data for undoing changes made to at least a mirrored file.

24. A method comprising
providing a communication network;
providing a first file stored in a first local data store, the first file comprising first file data and first system data;
mirroring the first file data via the communication network for storing a copy of the first file data in each of a plurality of other local data stores;
deleting the first file from the first local data store;
in response to deleting the first file:
initiating a process in dependence upon the file system data wherein the process comprises requesting via the communication network the deletion of a copy of the first file in at least one of the plurality of other local data stores; and
deleting the copy of the first file in the at least one of the plurality of other local data stores.

25. A method according to claim 24 comprising deleting the first file by selecting the first file via a utility.

26. A method comprising
providing a communication network;
providing a first file stored in a first local data store, the first file comprising first file data and first system data;
mirroring the first file data via the communication network for storing a copy of the first file data in each of a plurality of other local data stores;
deleting one of the first file from the first local data store and the mirrored copy of the first file from a respective one of the plurality of other local data stores;
in response to deleting the first file:
initiating a process in dependence upon the file system data wherein the process comprises requesting via the communication network the deletion of the copy of the first file in at least one of the plurality of other local data stores; and
deleting the copy of the first file in the at least one of the plurality of other local data stores.

27. A method according to claim 26 comprising deleting the first file by selecting the first file via a utility.

28. A method comprising:
mirroring a first file stored in a first folder in a first memory store to a second file in a second folder of a second memory store, the second memory store remote from the first memory store;
entering a first table entry into a first table stored in a third memory store, the first table entry comprising an indication of:
a location of the first file, indicating that the first file is stored in the first folder, the first folder stored within the first memory store;
the location of the second file, indicating that the second file is stored in the second folder stored within the second memory store; and
that the second file is a mirror of the first file.

29. A method according to claim 28 comprising:
moving the first file from the first file folder stored in the first memory store to a third folder stored in the first memory store; and
modifying the first table entry wherein the modified first table entry indicates that the first file is stored in the third folder stored within the first memory store.

30. A method according to claim 28 comprising:
modifying the first file;
searching the first table for a table entry comprising an indication of the location of the first file;
finding the first table entry in the first table;
locating the second file based on the indication of the location of the second file in the first table entry; and
synchronizing the second file with the first file.
